(19) United States
(12) Patent Application Publication
(10) Pub. No.: US 2024/0010349 A1
(43) Pub. Date: Jan. 11, 2024

(54) ASSEMBLY FOR MOUNTING AN UNDERWING PYLON TO A RIB OF AN AIRCRAFT WING

(71) Applicant: LEONARDO S.P.A., Roma (IT)

(72) Inventor: Franco Alfio DI MARIA, Volpiano (Torino) (IT)

(21) Appl. No.: 18/037,429

(22) PCT Filed: Apr. 21, 2022
(86) PCT No.: PCT/IB2022/053717

§ 371 Date: May 17, 2023

(30) Foreign Application Priority Data
Apr. 23, 2021 (IT) 102021000010319

(51) Int. Cl. B64D 29/02; F16B 5/02

(52) U.S. Cl. CPC B64D 29/02; F16B 5/02

(57) ABSTRACT

An assembly for removably mounting an underwing pylon to a rib of an aircraft wing is provided. The assembly has a prismatic body insertable into a prismatic cavity of the underwing pylon, a threaded retaining element having an upwardly tapered outer conical surface, and a vertical threaded pin inserted through a vertical through hole of the prismatic body. The assembly has an anti-rotation device for rotationally locking the threaded retaining element to the prismatic body relative to a vertical axis.

### TECHNICAL FIELD

The present invention pertains to the field of aircraft construction and relates to an assembly for removably mounting an underwing pylon to a rib of an aircraft wing.

### BACKGROUND ART

In aviation, the term “underwing pylon” (or wing pylon) refers to a rigid, structural fairing element that is mounted by threaded couplings to the underside of a wing and is used to support an underwing load such as engine nacelles, wing tanks, or armaments. The type of load depends on the flight mission to be performed by the aircraft and requires a dedicated underwing pylon to be mounted. When the flight mission is changed, the underwing load is replaced and therefore the removal of the underwing pylon is also required.

A problem that is felt, caused by the removal of the underwing pylons, which in many cases causes damage to the primary structure of the wing. The damage does not allow for the pylon to be remounted, except after a significant repair; this may involve the problem that, in the case of repeated damage to a part that has already been repaired, the possibility of carrying out further repairs will probably be affected, with the risk that the support system of the pylon will be forever jeopardized.

For a better understanding of the state of the art and its inherent problems, reference is made to FIGS. 1 and 2 of the attached drawings. An inner rib 10 of the wing of an aircraft has a conical seat 18 adapted on the bottom to receive and retain a removable underwing pylon assembly 11. The mounting assembly comprises: a prismatic body 12 having a central hole 21, through which a threaded pin 13, also known as a “yaw spigot,” is passed; a threaded retaining element 14 having a conical outer surface 15; a conical bushing 16; and a top nut 17. In the mounted condition, the conical bushing is forcibly locked by radial interference between the lower seat 18 of the rib and the conical surface 15 of the threaded retaining element 14. The top nut 17 is screwed onto an outer threaded surface of the threaded retaining element 14; said element has a threaded inner hole 19 into which the threaded pin 13 is screwed and a wrench formed in its flanged base to allow screwing. The threaded pin 13 has a lower head 20 to which the tightening and unscrewing torques apply. The prismatic body 12 is received in a correspondingly shaped prismatic through seat 22 formed through the body of the pylon 11. The threaded pin 13 is coupled to the retaining element 14 with a prescribed tightening torque to prevent accidental unscrewing from the wing.

To remove the pylon, an unscrewing torque must be applied to the threaded pin 13 that is in some cases greater than the technical installation specification. Excessive unscrewing torques may also involve an unwanted rotation of the top nut and conical bushing 16 together with the threaded retaining element 14, with damage resulting to the seat 18 made in the rib; said rib, in fact, is made of a metal material (aluminum or aluminum alloy) that is more deformable than the steel from which the nut, conical bushing, and threaded retaining element are made. Damage of this kind to a structural part of the wing requires extensive repairs to restore the lost mechanical properties.

### SUMMARY OF THE INVENTION

Thus, it is an object of the present invention to overcome the above-described drawback. The invention proposes to implement an anti-rotation configuration for disassembling an underwing pylon, primarily addressing the problem of avoiding damage to the structure of the wing while the pylon is disassembled.

The aforesaid and other objects and advantages are achieved according to this invention by a mounting assembly having the features set out in the appended independent claim 1. Advantageous embodiments are specified in the dependent claims, the content of which is to be understood as an integral part of the description that follows.

In summary, the assembly for mounting an underwing pylon to a rib of the wing comprises an anti-rotation device that transfers torsional stresses, which may occur while disassembling the underwing pylon, to said pylon and not to the structure of the wing.

### BRIEF DESCRIPTION OF THE DRAWINGS

The features of some preferred embodiments of an anti-rotation configuration according to the invention will now be described. Reference is made to the accompanying drawings, wherein:

FIG. 1 is a partial perspective view of an underwing pylon;

FIG. 2 is an exploded perspective view of the elements for mounting an underwing pylon to a rib according to the prior art;

FIG. 3 is an exploded perspective view of elements of an assembly for mounting an underwing pylon to a rib according to an embodiment of the present invention;

FIG. 4 is an exploded perspective view of the components of an anti-rotation device that is part of the assembly in FIG. 3;

FIG. 5 is a plan view from above of an underwing pylon with part of the anti-rotation device at an intermediate stage before mounting to a rib of a wing;

FIG. 6 is an exploded perspective view of the underwing pylon, the anti-rotation device components, and the rib of a wing;

FIG. 7 is a partial vertical section view of the underwing pylon mounted to the rib of a wing;

FIG. 8 is a partial cutaway perspective view of the anti-rotation device mounted to a wing; and

FIG. 9 is an exploded perspective view in an enlarged scale of some of the elements of the assembly in FIG. 3.

### DETAILED DESCRIPTION

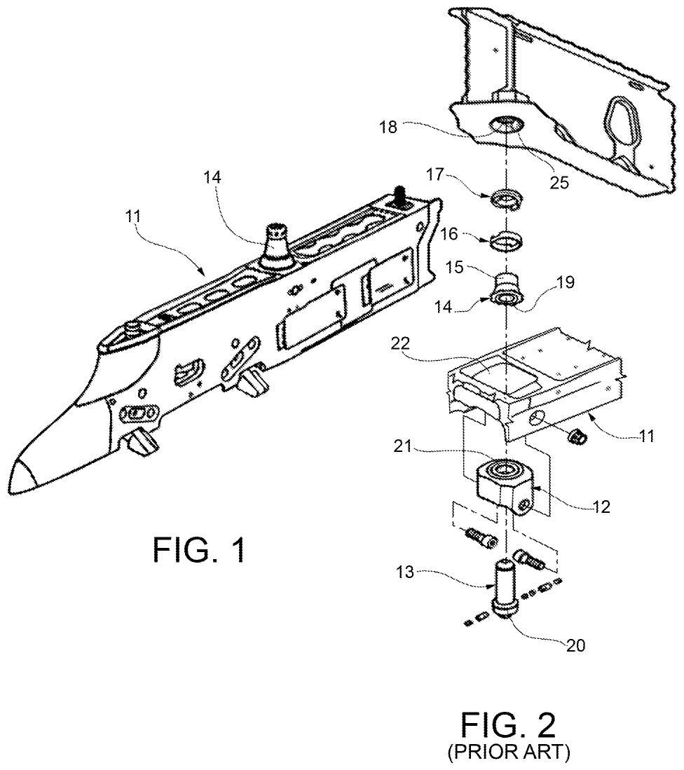

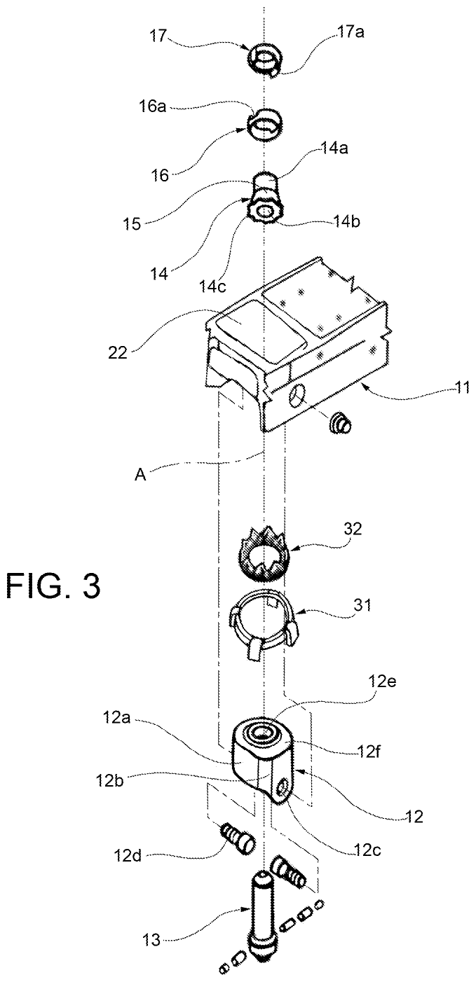

Referring to FIG. 3, there is illustrated an assembly for removably mounting an underwing pylon of the type shown in FIG. 1 to a rib of a wing designated at 10 in FIG. 2.

The structural features of the pylon 11 and the rib 10 are known in the art and need not be described in detail here. It will suffice here to mention that the rib 10 has a lower surface on which there is a plurality of cavities 18, each having a respective conical surface 25 tapering upward, and that the pylon has a plurality of substantially prismatic seats 22 in the form of vertical through openings.

According to an embodiment, an assembly for removably mounting the pylon to the rib comprises: a prismatic body 12, a vertical threaded pin 13, a threaded retaining element 14, a conical bushing 16, a top nut 17, and an anti-rotation device comprising a first lower annular anti-rotation element 31, and a second upper annular anti-rotation element 32.

In this context, terms and expressions indicating positions and orientations such as “vertical,” “axial,” “longitudinal,” “radial,” and “tangential” are intended to refer to the vertical direction indicated by the axis A along which the threaded pin 13 extends.

The prismatic body 12, known per se, has an overall square or rectangular horizontal cross-sectional shape with beveled vertices with four vertical lateral faces 12a joined in pairs by intermediate chamfered faces 12b, each forming an obtuse angle with both lateral faces 12a contiguous thereto. In the mounted condition, the prismatic body 12 is accommodated with slight play in one of the prismatic seats 22 formed in the pylon and is attachable to the pylon body. Typically, the prismatic body 12 may have horizontal holes 12c for connecting to the pylon body by means of bolts 12d.

The prismatic body 12 has a top surface 12f and a central hole 12e through which a traditional threaded pin 13, also known as a “yaw spigot,” is passed.

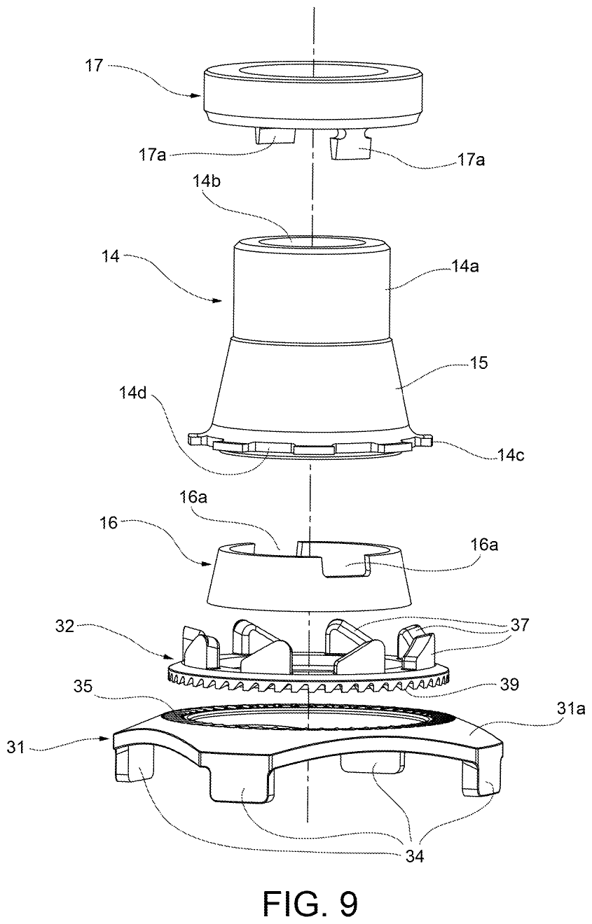

The threaded retaining element 14 has an upwardly tapered outer conical surface 15, a threaded upper and outer cylindrical surface 14a, a threaded inner cylindrical cavity 14b, and a lower flange 14c with a plurality of circumferentially spaced recesses 14d (FIG. 9). The threaded inner cylindrical cavity 14b serves to receive the threaded pin 13, while the outer cylindrical threaded surface 14a is used to screw in the top nut 17. The recesses 14d are preferably made as peripheral recesses elongated in tangential directions and equidistant from each other. According to a preferred embodiment, the recesses 14d open in radially outer directions along the periphery of the flange 14c.

The conical bushing 16 is fitted to the outer conical surface 15 of the threaded retaining element and may have a recess 16a in which a retaining protrusion 17a of the nut 17 may be engaged for rotationally retaining the bushing, in the mounted condition, with respect to the retaining element 14.

The two lower annular anti-rotation elements 31 and upper annular anti-rotation elements 32 serve to transfer stresses and tensions resulting from the application of unscrewing torques to the pylon 11 from the retaining element 14, as explained below.

The first annular anti-rotation element, denoted with 31, is adapted to cooperate with the prismatic body 12 and with the second annular anti-rotation element 32. The first annular anti-rotation element 31 has a central circular hole 33 and a plurality of peripheral fixing tabs 34. The fixing tabs 34 are oriented in substantially vertical planes and are angularly spaced apart and locked immovably on the prismatic element 12; in particular, the fixing tabs 34 grip and tighten the prismatic element 12 by acting against various chamfered vertical lateral faces 12b thereof. The first annular anti-rotation element 31 has an upper surface 37 having a first plurality of upward-facing engagement portions 35 distributed around the first annular anti-rotation element according to a given first step. Preferably, the engagement portions 35 are in the form of recesses 35 open towards the top and distributed around the circular hole 33.

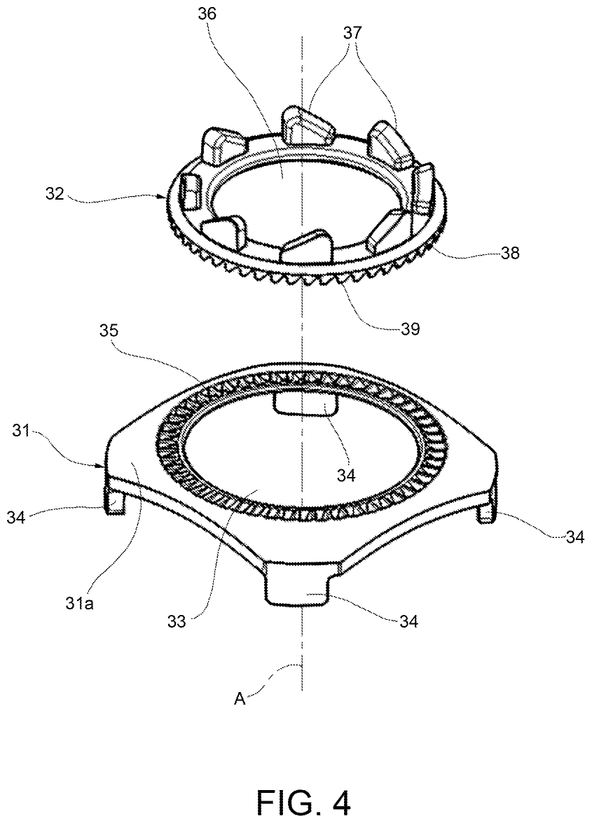

In the embodiment shown in FIG. 4, the top surface 37 of the first annular anti-rotation element 31 is provided with a plate-like portion having a partially hemispherical shape, corresponding to the top surface 12f of the prismatic body 12.

The second annular anti-rotation element 32, is adapted to cooperate with the first annular anti-rotation element 31 and the retaining element 14. The second annular anti-rotation element 32 has a central hole 36, an upper crown of upper locking teeth 37 arranged about the hole 36, and a second plurality of downward-facing engagement portions 38, in this example, in the form of a lower crown of lower locking teeth 38 arranged about the hole 36. The lower locking teeth 38 are configured to engage with the recesses 35 on the first annular anti-rotation element 31 to make the two annular elements rotationally integral.

The upper locking teeth 37 have a pitch and size corresponding to the pitch and size of the recesses 14d of the flange of the retaining element 14 so as to engage respective recesses 14d to prevent the relevant rotations between the second annular anti-rotation element 32 and the retaining element 14. To facilitate the insertion into the recesses 14d, the upper locking teeth are preferably shaped like saw teeth with inclined surfaces.

The lower locking teeth 38 of the second annular anti-rotation element 32 have a pitch and size corresponding to the pitch and size of the recesses 35 provided by the first annular anti-rotation element 31.

The pitch of the lower locking teeth 38 of the second annular anti-rotation element 32 and the recesses 35 of the first annular anti-rotation element 31 is advantageously smaller than the pitch of the upper locking teeth 37 of the second annular anti-rotation element and the recesses 14d of the engagement element flange 14 so that the mutual angular position between the first and second annular anti-rotation elements may be finely and precisely adjusted.

Preferably, to make mounting easier, the lower locking teeth 38 of the second annular anti-rotation element 32 have lower surfaces 39 inclined in the same circumferential direction.

According to a particularly advantageous embodiment, the inclined lower surfaces 39 of the lower locking teeth 38 of the second annular anti-rotation elements 32 are inclined in directions parallel to the inclination directions of the upper locking teeth 37, which are shaped like saw teeth and are located at corresponding circumferential positions.

For mounting the underwing pylon to the rib, the first annular anti-rotation element is attached to the prismatic body 12. The fixing tabs 34 are tightened against respective lateral faces of the prismatic body 12, preferably against the intermediate chamfered faces 12b.

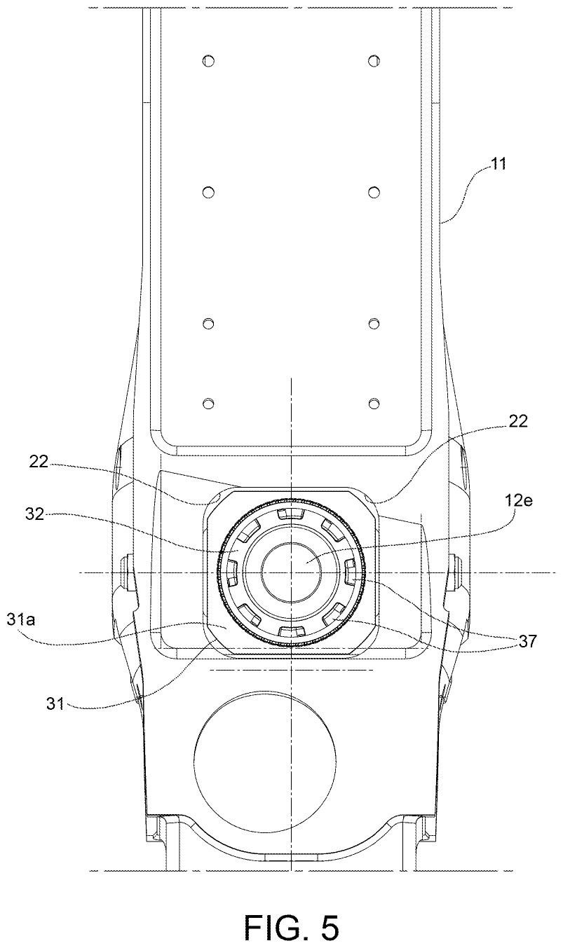

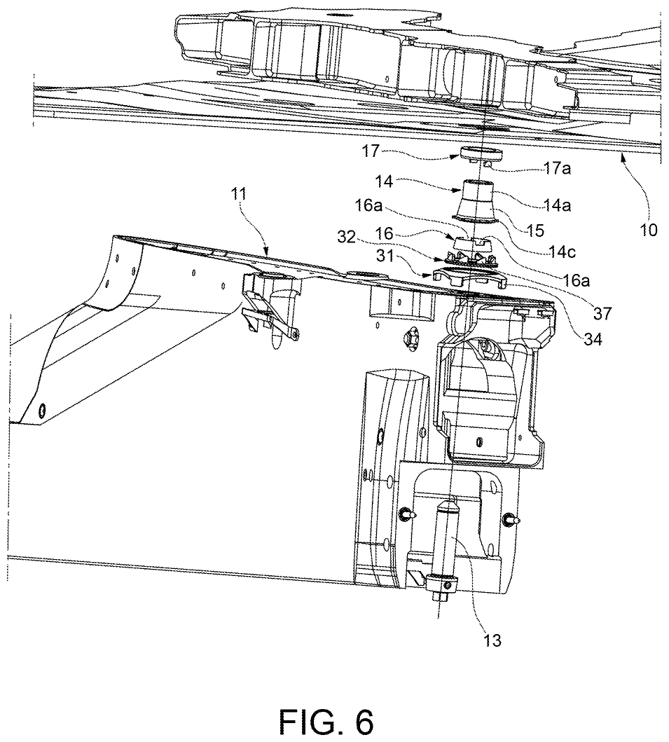

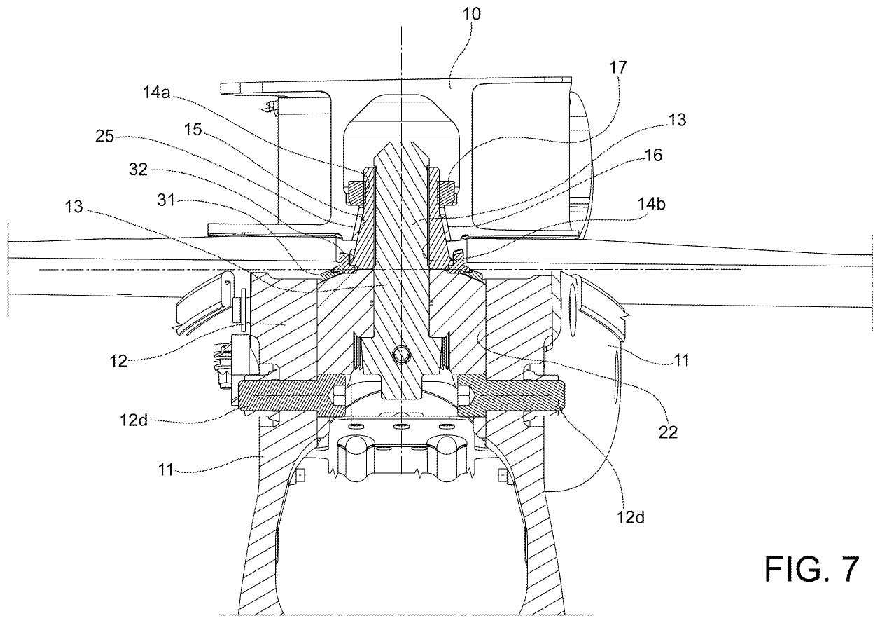

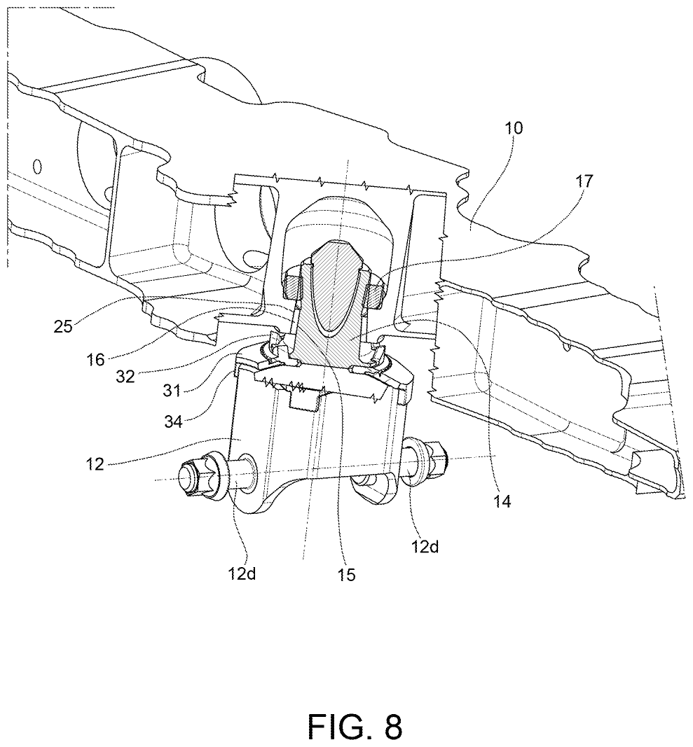

The prismatic body with the annular anti-rotation elements is inserted into the prismatic seat 22 of the pylon (FIG. 5).

The conical bushing 16 is fitted onto the conical surface 15 of the retaining element 14, and the retaining element 14 is inserted into the cavity 18, bringing the conical bushing 16 against the conical surface 25 of the cavity 18.

The nut 17 is screwed onto the outer cylindrical threaded surface 14a of the retaining element 14. The pylon is then lifted by bringing it against the lower surface of the rib; the second annular anti-rotation element 32 is coupled to the retaining element 14, inserting and engaging the upper locking teeth 37 in the recesses 14d formed in the flange 14c. At this stage, the relevant angular position between the first and second annular anti-rotation elements may be adjusted. Subsequently, the threaded pin 13 is screwed into the threaded inner cylindrical cavity 14b of the retaining element 14e with a prescribed torque, tightening the retaining element 14 and the conical bushing 16 against the conical surface of the rib as a packet.

During disassembling, an unscrewing torque is applied to the pin 13 to unscrew it from the retaining element 14. The torsion reactions of the retaining element 14 are transferred via the anti-rotation elements 31 and 32 to the prismatic body 12 and from there to the inner walls of the prismatic seat 22 of the pylon. The rotation of the retaining element 14 and the top nut 17 is therefore not counteracted by the aluminum alloy rib, which is therefore not damaged.

As may be appreciated, the torsional unscrewing stresses are no longer transmitted to the rib of the wing, but are deflected onto the steel body of the pylon.

The embodiments comprising, as in the illustrated example, two associated anti-rotation elements, are preferable and advantageous, as they allow the retaining element 14 to be angularly locked in whichever angular position it is in with respect to the sub-wing pylon. Alternative embodiments (not illustrated) may include a single annular anti-rotation element having fixing tabs similar to those illustrated with 34 to lock angularly to the prismatic body, and other means for the rotationally lockable engagement to the retaining element 14.

Various aspects and embodiments of the invention have been described. It is understood that each embodiment may be combined with any other embodiment. Moreover, the invention is not limited to the embodiments described, but may be varied within the scope defined by the appended claims.

1. An assembly for removably mounting an underwing pylon to a rib of an aircraft wing, the assembly comprising:
a prismatic body connectable to the underwing pylon and insertable in a corresponding prismatic cavity formed in the underwing pylon;
a vertical threaded pin inserted through a vertical through hole of the prismatic body;
a threaded retaining element comprising an upwardly tapered outer conical surface, a threaded upper and outer cylindrical surface, a threaded inner cylindrical cavity adapted to receive the vertical threaded pin, and a lower flange;
a conical bushing arranged on the outer conical surface of the threaded retaining element; and
a nut threadedly coupled to the threaded upper and outer cylindrical surface;
the assembly further comprising an anti-rotation device for rotationally locking the threaded retaining element to the prismatic body with respect to a vertical axis.

2. The assembly of claim 1, wherein the anti-rotation device comprises
at least one annular anti-rotation element arranged on a top surface of the prismatic body,
a first plurality of locking portions rotationally integral with said at least one annular anti-rotation element and acting against respective resisting surfaces of the prismatic body, and
a second plurality of locking portions rotationally integral with said at least one annular anti-rotation element and engaged with corresponding anti-rotation portions provided by the lower flange of the threaded retaining element.

3. The assembly of claim 2, wherein the anti-rotation device comprises two rotationally integral annular anti-rotation elements:
a first annular anti-rotation element arranged on the top surface of the prismatic body and having said first plurality of locking portions and a first plurality of upwardly facing engagement portions distributed around the first annular anti-rotation element according to a first given pitch; and
a second annular anti-rotation element arranged on the first annular anti-rotation element and having said second plurality of locking portions and a second plurality of downwardly facing engagement portions distributed around the second annular anti-rotation element according to said first pitch and engaged with said first plurality of upwardly facing engagement portions of the first annular anti-rotation element,
wherein the second plurality of locking portions is distributed about the second annular anti-rotation element according to a second pitch greater than said first pitch.

4. The assembly of claim 2, wherein the first plurality of locking portions comprises fixing tabs acting respectively against said resisting surfaces of the prismatic body, the resisting surfaces being shaped as vertical lateral faces.

5. The assembly of claim 4, wherein the prismatic body comprises a plurality of vertical lateral faces joined in pairs by intermediate chamfered lateral faces each forming an obtuse angle with both the vertical lateral faces contiguous thereto, and the locking portions act against said intermediate chamfered lateral faces.

6. The assembly of claim 3, wherein the anti-rotation portions provided by the lower flange comprise peripheral recesses elongated in tangential directions and equally spaced from one another about the lower flange.

7. The assembly of claim 6, wherein the peripheral recesses are open in radially outer directions along a periphery of the lower flange.

8. The assembly of claim 6, wherein the second plurality of locking portions of the second annular anti-rotation element comprises upper locking teeth engaged in the peripheral recesses,
wherein the upper locking teeth are shaped like saw teeth with upper surfaces inclined in a same circumferential direction,
wherein the second plurality of downwardly facing engagement portions of the second annular anti-rotation element comprises lower locking teeth shaped as saw teeth with lower surfaces inclined in a same circumferential direction, and wherein
the lower surfaces of the lower locking teeth of the second annular anti-rotation element are inclined in directions substantially parallel to inclination directions of the upper locking teeth located in corresponding circumferential positions.

9. The assembly of claim 3, wherein the first annular anti-rotation element comprises an upper surface provided by a plate portion having a partially hemispherical shape, curved at least partially corresponding to the top surface of the prismatic body.

10. An aircraft with two wings, each wing having a plurality of ribs, wherein at least one underwing pylon is removably mounted to at least one rib of the plurality of ribs by the assembly of claim 1.
